(19) United States
(12) Patent Application Publication
(10) Pub. No.: US 2023/0214950 A1
(43) Pub. Date: Jul. 6, 2023

(54) PREDICTION DEVICE, PREDICTION METHOD, AND RECORDING MEDIUM

(71) Applicant: NEC Corporation, Minato-ku, Tokyo (JP)

(72) Inventor: Takeshi Hara, Tokyo (JP)

(73) Assignee: NEC Corporation, Minato-ku, Tokyo (JP)

(21) Appl. No.: 17/919,329

(22) PCT Filed: Apr. 23, 2020
(86) PCT No.: PCT/JP2020/017466

§ 371 Date: Oct. 17, 2022

(51) Int. Cl. G06Q 50/20; G06N 20/00

(52) U.S. Cl. CPC G06Q 50/205; G06N 20/00

(57) ABSTRACT

In the prediction device, the acquisition means acquires student data related to the student. The preprocessing means generates training data based on the student data. The learning means generates at least one model that predicts the promotion situation of students based on the training data, by machine learning. The prediction means predicts the promotion situation of a subject student from the student data of the subject student using the generated model.

### TECHNICAL FIELD

The present invention relates to a technique for predicting promotion situations of students.

### BACKGROUND ART

There is proposed a method for predicting dropouts, such as leaving school and expulsion of students, based on the student’s performance and the status of completion of course subjects, etc. For example, Patent Document 1 describes a method for creating a model that calculates a risk of student’s leaving school using the presence or absence of leaving school of students and an attribute value indicating a correlation with leaving school, and predicting the possibility of student’s leaving school using this model.

### PRECEDING TECHNICAL REFERENCES

### Patent Document

Patent Document 1: Japanese Patent Application Laid-Open under No. 2016-114694

### SUMMARY

### Problem to Be Solved by the Invention

However, in the technique of Patent Document 1, since the bias of the training data and the complexity of the learned model are not considered, the prediction accuracy may be reduced.

It is an object of the present invention to provide a prediction device capable of predicting a promotion situation, such as repeating a year or leaving school of a student, with high accuracy.

### Means for Solving the Problem

According to an example aspect of the present invention, there is provided a prediction device comprising:
an acquisition means configured to acquire student data related to students;
a preprocessing means configured to generate training data based on the student data;
a learning means configured to generate at least one model for predicting a promotion situation of a student based on the training data by machine learning; and
a prediction means configured to predict the promotion situation of a subject student from the student data of the subject student using the model.

According to another example aspect of the present invention, there is provided a prediction method comprising:
acquiring student data related to students;
generating training data based on the student data;
generating at least one model for predicting a promotion situation of a student based on the training data by machine learning; and
predicting the promotion situation of a subject student from the student data of the subject student using the model.

According to still another example aspect of the present invention, there is provided a recording medium recording a program, the program causing a computer to execute:
acquiring student data related to students;
generating training data based on the student data;
generating at least one model for predicting a promotion situation of a student based on the training data by machine learning; and
predicting the promotion situation of a subject student from the student data of the subject student using the model.

### Effect of the Invention

According to the present invention, it is possible to provide a prediction device capable of predicting a promotion situation, such as repeating a year or leaving school of a student, with high accuracy.

### BRIEF DESCRIPTION OF THE DRAWINGS

FIG. 1 shows an outline of a prediction device according to a first example embodiment of the present invention.

FIG. 2 is a block diagram showing a hardware configuration of the prediction device.

FIG. 3 is a block diagram showing a functional configuration of the prediction device at the time of prediction.

FIG. 4 shows an example of a model used by the prediction device.

FIGS. 5A and 5B show examples of classification of student data by a classification unit.

FIG. 6 is a flow chart of prediction process by the prediction device.

FIG. 7 is a block diagram showing a functional configuration of the prediction device at the time of learning.

FIGS. 8A and 8B show examples of classification conditions used at the time of learning the prediction device.

FIG. 9 is a flowchart of a model generation process by the prediction device.

FIG. 10 is a block diagram showing a functional configuration of a prediction device according to the second example embodiment.

### EXAMPLE EMBODIMENTS

Preferred example embodiments of the present invention will be described with reference to the accompanying drawings.

### <First Example Embodiment>

### [Basic Concept]

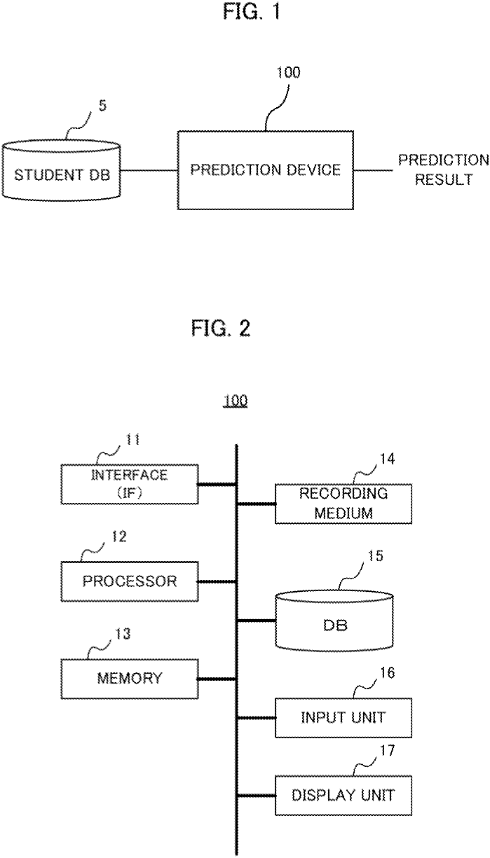

FIG. 1 shows an outline of a prediction device according to a first example embodiment of the present invention. The prediction device 100 is connected to a student database (DB) 5. The student DB 5 stores various types of data related to students who go to schools such as universities or technical schools (hereinafter, also referred to as “student data”). The prediction device 100 predicts the promotion state including repeating a year, leaving school, or the like of the student and the possibility of going up to the next grade (hereinafter referred to as the “promotion situation”) based on the student data. Specifically, when predicting the promotion situation of a student, the prediction device 100 acquires student data about the student subjected to the prediction (hereinafter, also referred to as the “target student”) from the student DB 5. Then, although the details will be described later, the prediction device 100 predicts the promotion situation of the target student, such as repeating a year or leaving school of the target student, using a model for estimating the promotion situation based on the student data. Also, the prediction device 100 outputs the prediction result to an external device, if necessary.

### [Hardware Configuration]

FIG. 2 is a block diagram showing the hardware configuration of the prediction device 100. As illustrated, the prediction device 100 includes an interface (IF) 11, a processor 12, a memory 13, a recording medium 14, a database (DB) 15, an input unit 16, and a display unit 17.

The IF 11 inputs and outputs data to and from external devices. Specifically, the prediction device 100 acquires student data from the student DB 5 through the IF 11. Further, the prediction result generated by the prediction device 100 is outputted to the external device through the IF 11 as needed.

The processor 12 is a computer such as a CPU (Central Processing Unit) and controls the entire prediction device 100 by executing a program prepared in advance. Specifically, the processor 12 executes a prediction process and a model generation process to be described later.

The memory 13 is composed of ROM (Read Only Memory), RAM (Random Access Memory), and the like. The memory 13 is also used as a work memory during the execution of various processes by the processor 12.

The recording medium 14 is a non-volatile, non-transitory recording medium such as a disk-shaped recording medium, a semiconductor memory, or the like, and is configured to be detachable from the prediction device 100. The recording medium 14 records various programs to be executed by the processor 12. When the prediction device 100 executes various kinds of processes, a program recorded on the recording medium 14 is loaded into the memory 13 and executed by the processor 12.

The DB 15 stores student data inputted through the IF 11, prediction results generated by the prediction device 100, and the like. The DB 15 also stores models used to predict promotion situations and training data used to learn the models. The model used for prediction is a model learned by machine learning, which may be one using a neural network, or may be one using other machine learning methods.

The input unit 16 is, for example, a keyboard, a mouse, or the like, and is used by a user to perform instructions or inputs when the prediction process or the model generation process to be described later is executed. The display unit 17 is, for example, a liquid crystal display or the like, and displays an operation screen used by the user and the prediction result generated by the prediction device 100.

### [Functional Configuration for Prediction]

The prediction device 100 performs prediction using heterogeneous mixture learning. In the heterogeneous mixture learning, a prediction model defined by a set of trees (tree structure) formed by nodes representing conditional branches and multiple linear models is generated, and one prediction model is assigned to the leaf of each tree. When using this prediction model, first, the tree is traced from the root to the leaves using the data of the prediction object (combinations of values of each data item). Then, the value of the objective variable is obtained by inputting the data of the prediction object to the linear model corresponding to the arriving leaf. The heterogeneous mixture learning is described in U.S. Pat. Application Publication No. 2014/0222741A1 and the content of this document is incorporated herein by reference. The learning method of the heterogeneous mixture learning will be described in the section of [Model Generation Process] described later. By utilizing the heterogeneous mixture learning, the prediction device 100 can perform prediction with higher accuracy.

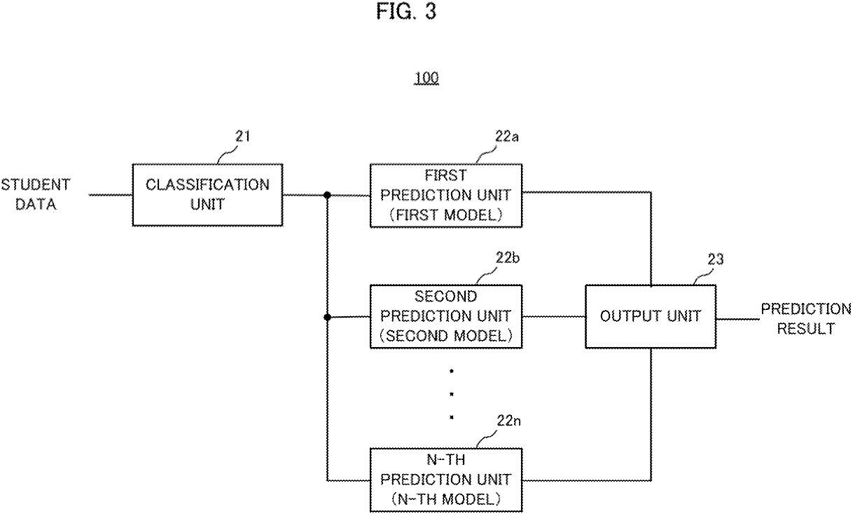

FIG. 3 is a block diagram showing a functional configuration at the time of prediction by the prediction device 100. The prediction device 100 functionally includes a classification unit 21, a first prediction unit 22a to an n-th prediction unit 22n, and an output unit 23. Incidentally, in the following description, the first prediction unit 22a to the n-th prediction unit 22n will be simply referred to as “the prediction unit 22” when each of them is not distinguished from each other.

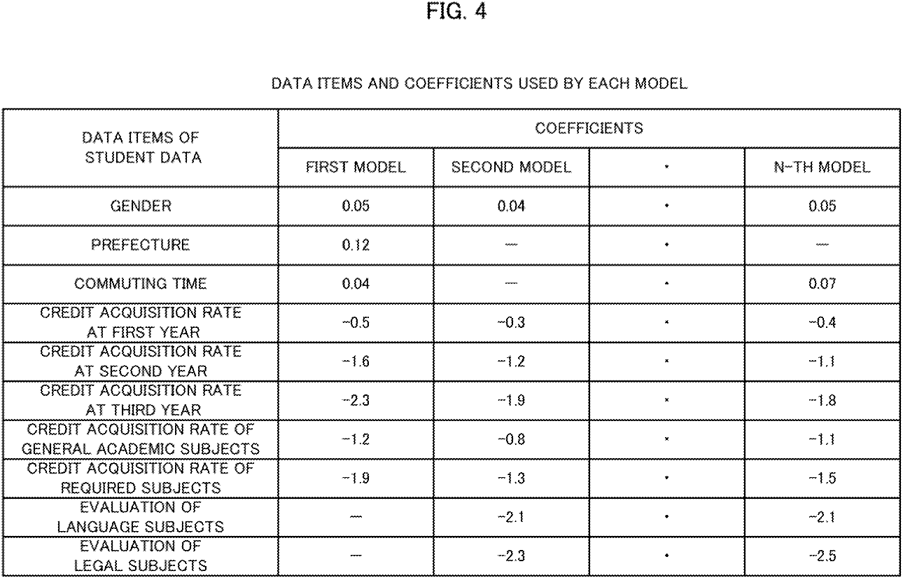

The classification section 21 acquires student data from the student DB 5 and classifies the student data based on the values of the data. The student data include various types of data for each student. For example, as shown in FIG. 4, the student data includes multiple data items such as the students’ gender, the prefecture, the commuting time, the credit acquisition rate in each school year, and the evaluation of each subject category. The classification unit 21 classifies the student data into a plurality of groups using a tree structure having conditional branches relating to data items, and outputs each student data after the classification to the first prediction unit 22a to the n-th prediction unit 22n.

Each of the first prediction unit 22a to the n-th prediction unit 22n predicts the promotion situation using one model. Here, “n” corresponds to the number of groups classified by the classification unit 21. Now, if the classification unit 21 classifies the student data into n groups including the first group to the n-th group, the first prediction unit 22a performs prediction of the students belonging to the first group using the first model, the second prediction unit 22b performs prediction of the students belonging to the second group using the second model, and the n-th prediction unit 22n performs prediction of the students belonging to the n-th group using the n-th model. The first to n-th models are the models that have been learned by machine learning, respectively. Each of the prediction units 22a to 22n outputs the prediction result to the output unit 23.

FIG. 4 shows an example of models used by the prediction unit 22. In this example, it is assumed that each model calculates the sum of the product of the values of each data item of the student data and the coefficients as a predicted value. The predicted values indicate the probability of moving up to the next grade or repeating a year of the target student, and the probability of leaving school. Each prediction unit 22 outputs the predicted value as a prediction result. Each coefficient shows the weight for each data item, and the data item that greatly affects repeating a year or leaving school of the student has the large value. The example in FIG. 4 implies that the positive coefficients have an effect on repeating a year, and the negative coefficients have an effect on not repeating a year. As will be appreciated from FIG. 4, a combination of different data items may be used for each model. In the example shown in FIG. 4, the first model does not use the evaluation of each subject category (“Evaluation of language subjects” and “Evaluation of legal subjects”), and the second model does not use “the prefecture” and “the commuting time”. That is, each model is generated so as to use the value of the data item that has a large influence on repeating a year or leaving school of the students belonging to the group corresponding to that model with a large weight, and use the value of the data item that has a small influence with a small weight or does not use the data item that has a small influence.

The output unit 23 receives the prediction result from the prediction unit 22 which actually performed the prediction for the target student, from among the plurality of prediction units 22, and outputs the prediction result. For example, when the target student belongs to the first group, the first prediction unit 22a generates the prediction result of the promotion situation of the target student and outputs the prediction result to the output unit 23. At this time, the second to n-th predictive units 22b to 22n do not perform prediction because they do not correspond to the group to which the target student belongs. Therefore, the output unit 23 outputs the prediction result outputted by the first prediction unit 22a.

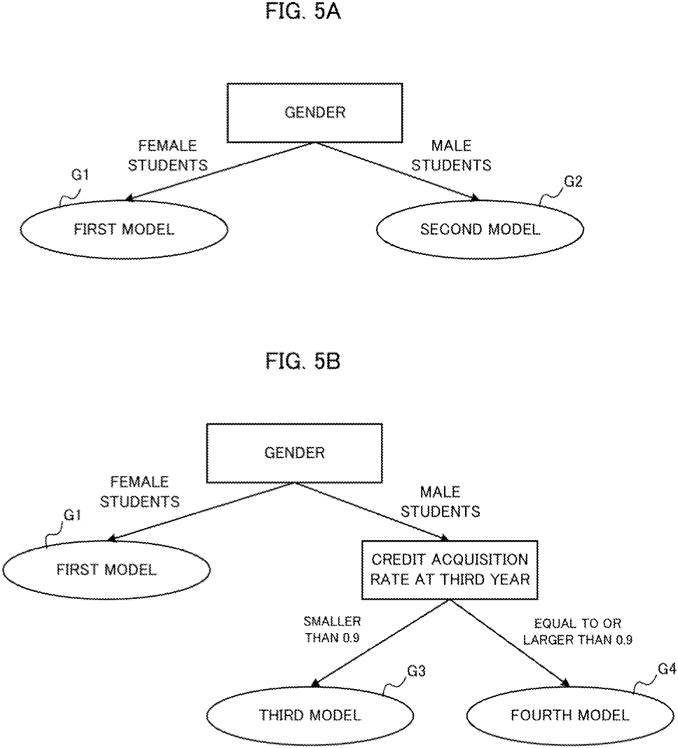

FIG. 5A shows an example of classification of the student data by the classification unit 21. In this example, the classification unit 21 uses “gender” as the data item that forms the node of the tree structure, and classifies all the student data into the group G1 of female students and the group G2 of male students. The prediction unit 22 performs prediction using different models for the groups. Specifically, the prediction unit 22 predicts the promotion situation using the first model for the students belonging to the group G1 of female students, and predicts the promotion situation using the second model for the students belonging to the group G2 of male students.

FIG. 5B shows another example of classification of the student data by the classification unit 21. In this example, the classification unit 21 uses “gender” and “a credit acquisition rate at 3rd year” as the data items forming the nodes, and classifies the students using a tree structure whose depth is two levels. The classification unit 21 classifies all the student data into the group G1 of female students, the group G3 of male students whose credit acquisition rate at 3rd year is smaller than 0.9, and the group G4 of male students whose credit acquisition rate at 3rd year is equal to or larger than 0.9. The prediction unit 22 performs prediction using different models for those groups. Specifically, the prediction unit 22 predicts the promotion situation using the first model for the students belonging to the group G1, predicts the promotion situation using the third model for the students belonging to the group G3, and predicts the promotion situation using the fourth model for the students belonging to the group G4.

Thus, in the present example embodiment, the prediction device 100 classifies the student data into a plurality of groups using the tree structure having condition branches relating to one or more data items included in the student data by heterogeneous mixture learning, and predicts the promotion situation of the target student using the model corresponding to the group to which the target student belongs. In the real world, the factors that cause students to repeat a year or leave school are often not simply academic achievements, but a combination of various factors. In this regard, in the present example embodiment, it is possible to accurately predict various cases in which factors indicated by multiple data items are combined to lead to repeating a year or leaving school, by using a model suitable for each case.

Incidentally, the data items of the student data shown in FIG. 4 are only an example, and various other data can also be used as the student data. Specifically, other than the credit acquisition rate, GPA (Grade Point Average) may be used as the data related to an academic performance. Also, among the credit acquisition rates for the subject categories, the student data may be used with particular attention to the subject in which students are prone to tripping, i.e., the subject categories for which students tend to drop a credit. Generally, if the credit acquisition rate and GPA of general academic subjects are low, it is unlikely that the students will repeat a year. However, if the credit acquisition rate and GPA of required subjects are low, it is likely that the students will repeat a year. In some cases, there is a correlation between the credit acquisition rate in a specific subject category and repeating a year. For example, there is a tendency that the probability of repeating a year is high when a student drops a credit of a specific legal subject. Therefore, it is effective to classify and use the data of the academic performance using the subject category from different viewpoint such as general academic subjects and required subjects, or laws and languages.

As the data related to the attribute of the students, a hometown or a home area, a high school, use of a scholarship, presence or absence of a delay in the payment of school expenses, and the like may be used, other than the data of the academic performance. Also, the data related to human relationships among students such as data related to the presence or absence a housemate (living alone, living with families), data related to the guarantor such as relationship, residential prefectures and regions of the guarantor, and data related to club activities and group activities. Further, in addition to the commuting time, commuting measures to school (trains, bicycles, motorcycles, etc.) may be used as data related to the student’s lifestyle. Still further, as data related to the motivation for learning habits and learning of students, time zone and time division of the course subject, use history of the library, situation of taking e-learning, existence of delay of report submission, examination history of qualification test and vocabulary examination, or the like may be used.

### [Prediction Process]

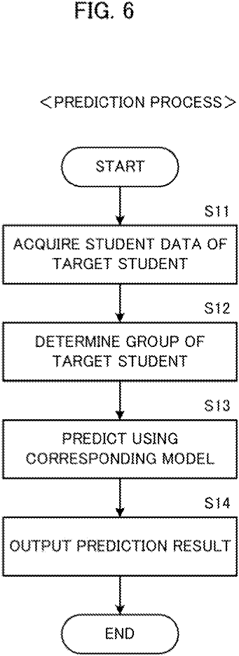

Next, a prediction process by the prediction device 100 will be described. FIG. 6 is a flowchart of the prediction process. This process is implemented by the processor 12 shown in FIG. 2 executing a program prepared in advance and operating as an element shown in FIG. 3.

First, the prediction device 100 acquires the student data of the target student from the student DB 5 (step S11). Next, the classification unit 21 determines the group to which the target student belongs based on the acquired student data (step S12). Next, the prediction unit 22 predicts the promotion situation of the target student using the student data of the target student (step S13). Specifically, among the plurality of prediction units 22a to 22n, the prediction unit 22 corresponding to the group determined in step S12 predicts the promotion situation of the target student using the learned model. The output unit 23 receives the prediction result from the prediction unit 22 that has performed the prediction, and outputs the prediction result (step S14). Incidentally, the output unit 23 may output the prediction result to an external device, may store the prediction result inside, or may display the prediction result on the display unit 17.

### [Functional Configuration During Learning]

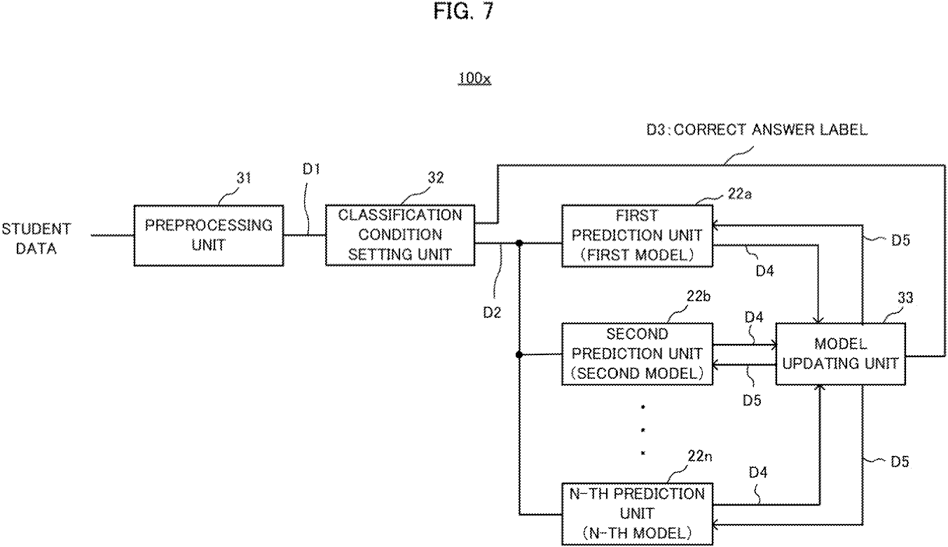

FIG. 7 is a block diagram showing a functional configuration at the time of learning of the prediction device. The prediction device 100x at the time of learning includes a preprocessing unit 31, a classification condition setting unit 32, first to n-th prediction units 22a to 22n, and a model updating unit 33. The first to n-th prediction units 22a to 22n are the same as those in the prediction device 100 at the time of prediction shown in FIG. 3. The prediction device 100x at the time of learning learns the first to n-th models used in the first to n-th prediction units 22a to 22n, respectively.

The preprocessing unit 31 performs preprocessing on the student data and generates training data D1 suitable for use in learning the model. The training data D1 is training data for training each model and includes input data D2 and correct answer labels (teacher labels) D3 indicating correct answers to the input data D2. Specifically, the input data D2 is the values of the data items included in the student data, i.e., the data items illustrated in FIG. 4. In addition, the correct answer label D3 for the input data D2 is data indicating whether or not the student corresponding to the student data has repeated a year or left school.

Further, when generating the training data, the preprocessing unit 31 increases the amount of the student data as necessary. Specifically, the preprocessing unit 31 generates additional data based on the student data collected for the students actually exist (hereinafter, referred to as “raw data”), and uses the additional data as the training data D1. Namely, the training data D1 includes the additional data thus increased, in addition to the raw data. The reason to increase the student data is to increase the student data for the conditions in which the amount of data is insufficient and thereby eliminate the bias of the overall data. Particularly, the number of students who actually repeat a year or leave school is small compared with the total number of the students. Therefore, in order to enhance the versatility of the model, it is effective to carry out learning with increasing the amount of data used to generate a model to predict the promotion situation of students such as repeating a year or leaving school.

For example, with respect to the data item “prefecture”, when there is little student data of students in A prefecture, the preprocessing unit 31 creates student data in A prefecture using the student data of B prefecture belonging to the same area as A prefecture. Similarly, with respect to the data item “commuting time”, when there is little student data for the commuting time “80 to 90 minutes”, the preprocessing unit 31 creates the student data for the commuting time “80 to 90 minutes” using the student data for the commuting time “60 to 70 minutes” and the commuting time “90 minutes or more”. In addition, when the student data of female students is smaller than that of male students, the student data of female students may be created to balance the student data of female students with the student data of male students. Thus, the preprocessing unit 31 generates a well-balanced training data D1 for various conditions by increasing the amount of student data as needed and outputs the training data D1 to the classification condition setting unit 32.

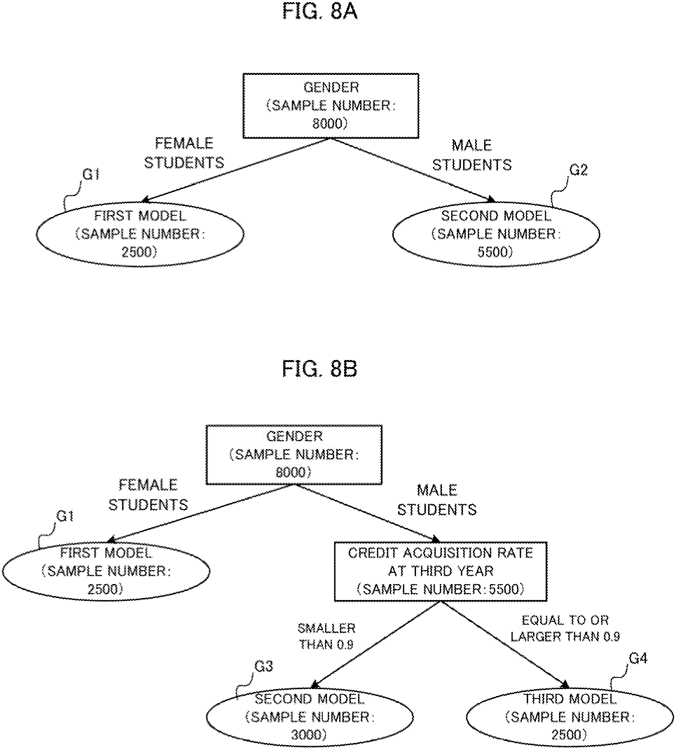

The classification condition setting unit 32 sets the classification condition of the training data D1 used for learning the model of each prediction unit 22. Here, the “classification condition” is defined by the tree structure exemplified in FIGS. 8A and 8B, and includes the number of models to be used, the depth of the hierarchy of the tree structure, the data items to be inputted to each model, and the branching conditions of the nodes based on the values of each data item. In other words, the classification condition is a condition that defines the group to which each model used by the prediction unit 22 is applied. Incidentally, the classification condition setting unit 32 initially sets the initial value previously set by the user or the like as the classification conditions, and thereafter sets the classification conditions by changing a portion of the classification conditions randomly.

Then, the classification condition setting unit 32 classifies the training data D1 into groups corresponding to the respective models based on the set classification conditions. Namely, the classification condition setting unit 32 extracts the input data D2 for each model used by the first to n-th prediction units 22a to 22n. For example, when “gender” is used as the data item forming a node of the tree structure as shown in FIG. 8A, the classification condition setting unit 32 extracts the training data D1 of the data item “gender” from the training data D1 generated by the preprocessing unit 31. Then, the classification condition setting unit 32 outputs the value of the data item “gender” to the first prediction unit 22a using the first model and the second prediction unit 22b using the second model as the input data D2, and outputs the correct answer label D3 indicating whether or not the students have repeated a year or left school to the model updating unit 33.

Further, when “gender” and “credit acquisition rate at 3rd year” are used as the data items forming the nodes of the tree structure as shown in FIG. 8B, the classification condition setting unit 32 extracts the training data D1 of the data items “gender” and “credit acquisition rate at 3rd year” from the training data D1 generated by the preprocessing unit 31. Then, the classification condition setting unit 32 outputs the value of the data item “gender” to the first prediction unit 22a using the first model as the input data D2, and outputs a correct answer label D3 indicating whether or not those students have repeated a year or left school to the model updating unit 33. Furthermore, the classification condition setting unit 32 outputs the value of the data item “gender” and the “credit acquisition rate of 3 years” to the second prediction unit 22b using the second model and the third prediction unit 22c using the third model as the input data D2, and also outputs the correct answer label D3 indicating whether or not the students have repeated a year or left school to the model updating unit 33.

Here, the classification condition setting unit 32 sets the classification condition according to the following constraints.

(Constraint A) The number of hierarchies of the tree structure used for classification is equal to or smaller than a specified number of hierarchies.

(Constraint B) The ratio of the number of samples of the training data for each model (each group) to the total number of samples (hereinafter referred to as the “sample number ratio”) is equal to or greater than a predetermined ratio.

The classification condition setting unit 32 sets the data items to be used by each model based on the tree structure illustrated in FIGS. 8A and 8B as the classification conditions. However, there are a large number of data items included in the student data, and if all of them are considered, the model may become too complicated or become over-fitting for a small number of exceptional data, resulting in an impractical model. Therefore, the classification condition setting unit 32 sets the depth of the tree structure to be a predetermined number or less based on the constraint A, so that the hierarchical structure of the model does not become too complicated.

Further, based on the constraint B, the classification condition setting unit 32 sets the number of samples of the training data used for learning of each model to be equal to or greater than a predetermined percentage of the total number of samples, so that learning using a small number of exceptional data is not performed. Specifically, in the example of FIG. 8B, the sample number ratio R1 to R3 of the group G1 to G3 to which the first to third models are applied is as follows.

$$\text{R1} = 2500 / 8000 = \text{approx} \text{. 31\%}$$

$$\text{R2} = 3000 / 8000 = \text{approx} \text{. 38\%}$$

$$\text{R3} = 2500 / 8000 = \text{approx} \text{. 31\%}$$

For example, assuming that the predetermined percentage in constraint B is set to 10%, the sample number ratios R1 to R3 for the group G1 to G3 corresponding to each model satisfy the constraint B.

As described above, the classification condition setting unit 32 uses the above constraints A and B so that the model does not become too complex or overlearning about a small number of exceptional data. Incidentally, as will be described later, the classification condition setting unit 32 generates a plurality of models while changing the number of hierarchies of the tree structure, the sample number ratio of the training data used for learning of one model, and the like.

Each prediction unit 22 calculates the predicted value of the promotion situation of the student such as the probability of repeating a year from the input data D2 inputted from the classification condition setting unit 32 using the model corresponding to itself, and outputs the predicted value as the prediction result D4 to the model updating unit 33.

The model updating unit 33 compares the prediction result D4 inputted from the prediction unit 22 with the correct answer label D3 inputted from the classification condition setting unit 32 for each prediction unit 22, and sends the update data D5 to each prediction unit 22 based on the errors to update the model of each prediction unit 22. Thus, learning of each model is carried out. When a predetermined condition is satisfied, the model updating unit 33 terminates updating the model and sets the obtained model as the learned model. Incidentally, the classification condition setting unit 32 and the model updating unit 33 form an example of learning means.

### [Model Generation Process]

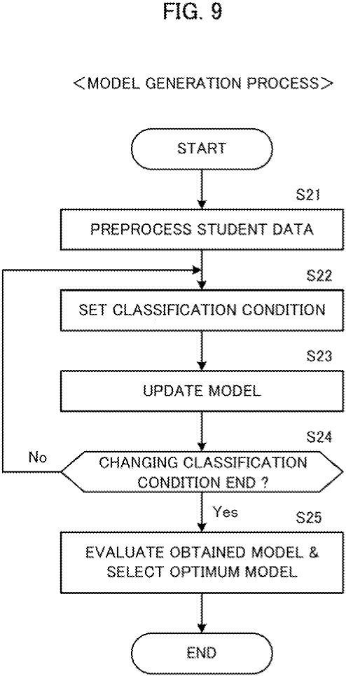

Next, a model generation process will be described. FIG. 9 is a flowchart of the model generation process by the prediction device. This process is realized by the processor 12 shown in FIG. 2 executing a program prepared in advance and operating as each element shown in FIG. 7.

First, the preprocessing unit 31 acquires student data from the student DB 5 and performs preprocessing (step S21). Specifically, the preprocessing unit 31 generates the training data D1 used to learn each model, i.e., the pairs of the input data D2 and the correct answer label D3, using the acquired student data. Incidentally, the preprocessing unit 31 generates the training data D1 by increasing the amount of student data under the condition that the number of data is insufficient, if necessary.

Next, the classification condition setting unit 32 sets the classification conditions for the plurality of models (step S22). Specifically, the classification condition setting unit 32 determines the classification conditions of the models used by each prediction unit 22 based on the tree structure exemplified in FIGS. 8A, 8B, and the like. Incidentally, at the first execution of the step S22, the classification condition setting unit 32 uses classification conditions set in advance by a user.

Next, the model updating unit 33 updates the respective models (step S23). Specifically, based on the input data D2 inputted from the classification condition setting unit 32, each prediction unit 22 first predicts the promotion situation using the model used by the prediction unit 22, and outputs the prediction result D4 to the model updating unit 33. The model updating unit 33 compares the prediction result D4 inputted from the prediction unit 22 with the correct answer label D3 inputted from the classification condition setting unit 32, and outputs the update data D5 to each prediction unit 22 based on the error to update the model. Thus, the model updating unit 33 updates the model used by each prediction unit 22.

Next, the classification condition setting unit 32 determines whether or not the scheduled change of the classification condition is completed (step S24). When the scheduled change of the classification condition has not been completed (step S24: No), the classification condition setting section 32 returns to step S22 to change the classification condition, and learns the model for the changed classification condition. Specifically, under the aforementioned constraints, the classification condition setting unit 32 randomly changes the number of hierarchies of the tree structure and the sample number ratio of the training data used for learning of each model. Thus, the model updating unit 33 generates learned models including the first to n-th models for a plurality of different classification conditions.

On the other hand, when the scheduled change of the classification condition is completed (step S24: Yes), the classification condition setting unit 32 evaluates the learned models corresponding to the obtained plurality of classification conditions, and selects the optimum models as a group of models to be used for the prediction process (step S25). Then, the model generation process ends.

Incidentally, in the above-described model generation process, a group of learned models is generated for all classification conditions scheduled in advance to compare their performances, and the optimum group of learned models is selected among them in step S25. Alternatively, a predetermined criterion may be used to determine the optimum group of models. That is, the model may be updated while changing the classification condition, the performance of the obtained group of learned models may be compared with a predetermined evaluation criterion, and the process may be terminated when a group of learned models having a performance exceeding the evaluation criterion is obtained.

### <Second Example Embodiment>

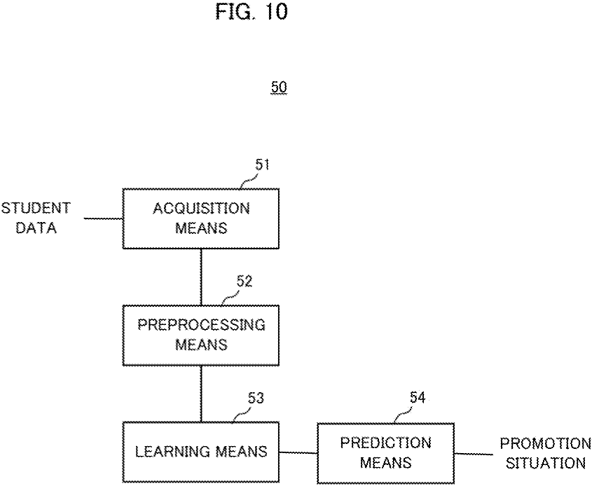

Next, a second example embodiment of the present invention will be described. FIG. 10 is a block diagram illustrating a functional configuration of a prediction device according to a second example embodiment. The prediction device 50 includes an acquisition means 51, a preprocessing means 52, a learning means 53, and a prediction means 54. The acquisition means 51 acquires student data related to students. The preprocessing means 52 generates training data based on the student data. The learning means 53 generates at least one model that predicts a promotion situation of the student based on the training data by machine learning. The prediction unit 54 predicts the promotion situation of a target student from the student data of the target student using the generated model.

A part or all of the example embodiments described above may also be described as the following supplementary notes, but not limited thereto.

### (Supplementary Note 1)

A prediction device comprising:
an acquisition means configured to acquire student data related to students;
a preprocessing means configured to generate training data based on the student data;
a learning means configured to generate at least one model for predicting a promotion situation of a student based on the training data by machine learning; and
a prediction means configured to predict the promotion situation of a subject student from the student data of the subject student using the model.

### (Supplementary Note 2)

The prediction device according to Supplementary note 1, further comprising a classification means configured to classify the student data into a plurality of groups based on values of the student data,
wherein the learning means learns the model for each group, and
wherein the prediction means predicts the promotion situation of the subject student using a model corresponding to the group to which the student data of the subject student belongs.

### (Supplementary Note 3)

The prediction device according to Supplementary note 2,
wherein the student data includes a plurality of data items, and
wherein the classification means classifies the student data into the plurality of groups based on a branch condition for each of the data items defined by a tree structure.

### (Supplementary Note 4)

The prediction device according to Supplementary note 3,
wherein the learning means performs a plurality of different classifications by changing a number of a hierarchy of the tree structure, while maintaining the number of the hierarchy of the tree structure below a predetermined number, and
wherein the learning means learns a group of models corresponding to the plurality of groups, for each classification result obtained by the plurality of classifications, and selects a group of models corresponding to one of the plurality of classification results.

### (Supplementary Note 5)

The prediction device according to Supplementary note 3 or 4,
wherein the learning means performs a plurality of different classifications by changing a ratio of a number of samples of the training data belonging to each of the plurality of groups to a total number of samples, while maintaining the ratio at a predetermined ratio or more, and
wherein the learning means learns a group of models corresponding to the plurality of groups, for each classification result obtained by the plurality of classifications, and selects a group of models corresponding to one of the plurality of classification results.

### (Supplementary Note 6)

The prediction device according to any one of Supplementary notes 1 to 5, wherein the preprocessing means changes the value of the student data to generate the training data for at least a portion of the data items of the student data.

### (Supplementary Note 7)

The prediction device according to any one of Supplementary notes 1 to 6, wherein the student data includes data items related to at least one of human relationship, lifestyle, learning habit, motivation for learning, and a factor affecting the promotion situation of the student.

### (Supplementary Note 8)

The prediction device according to any one of Supplementary notes 1 to 7, wherein the student data includes at least one of a credit acquisition rate and a GPA of the students for each subject category.

### (Supplementary Note 9)

The prediction device according to any one of Supplementary notes 1 to 8, wherein the student data includes a credit acquisition rate of a subject category that affects the promotion situation of the student.

### (Supplementary Note 10)

The prediction device according to any one of Supplementary notes 1 to 9, wherein the promotion situation includes at least one of repeating a year and leaving school of the students.

### (Supplementary Note 11)

A prediction method comprising:
acquiring student data related to students;
generating training data based on the student data;
generating at least one model for predicting a promotion situation of a student based on the training data by machine learning; and
predicting the promotion situation of a subject student from the student data of the subject student using the model.

### (Supplementary Note 12)

A recording medium recording a program, the program causing a computer to execute:
acquiring student data related to students;
generating training data based on the student data;
generating at least one model for predicting a promotion situation of a student based on the training data by machine learning; and
predicting the promotion situation of a subject student from the student data of the subject student using the model.

While the present invention has been described with reference to the example embodiments and examples, the present invention is not limited to the above example embodiments and examples. Various changes which can be understood by those skilled in the art within the scope of the present invention can be made in the configuration and details of the present invention.

### DESCRIPTION OF SYMBOLS

5 Student Database (DB)
12 Processor
13 Memory
15 Database (DB)
21 Classification unit
22a to 22n Prediction unit
23 Output unit
31 Preprocessing unit
32 Classification condition setting unit
33 Model updating unit
50, 100, 100x prediction device

What is claimed is:

1. A prediction device comprising:
a memory configured to store instructions; and
one or more processors configured to execute the instructions to:
acquire student data related to students;
generate training data based on the student data;
generate at least one model for predicting a promotion situation of a student based on the training data by machine learning; and
predict the promotion situation of a subject student from the student data of the subject student using the model.

2. The prediction device according to claim 1,
wherein the one or more processors classify the student data into a plurality of groups based on values of the student data,
wherein the one or more processors learn the model for each group, and
wherein the one or more processors predict the promotion situation of the subject student using a model corresponding to the group to which the student data of the subject student belongs.

3. The prediction device according to claim 2,
wherein the student data includes a plurality of data items, and
wherein the one or more processors classify the student data into the plurality of groups based on a branch condition for each of the data items defined by a tree structure.

4. The prediction device according to claim 3,
wherein the one or more processors perform a plurality of different classifications by changing a number of a hierarchy of the tree structure, while maintaining the number of the hierarchy of the tree structure below a predetermined number, and
wherein the one or more processors learn a group of models corresponding to the plurality of groups, for each classification result obtained by the plurality of classifications, and selects a group of models corresponding to one of the plurality of classification results.

5. The prediction device according to claim 3,
wherein the one or more processors perform a plurality of different classifications by changing a ratio of a number of samples of the training data belonging to each of the plurality of groups to a total number of samples, while maintaining the ratio at a predetermined ratio or more, and
wherein the one or more processors learn a group of models corresponding to the plurality of groups, for each classification result obtained by the plurality of classifications, and selects a group of models corresponding to one of the plurality of classification results.

6. The prediction device according to claim 1, wherein the one or more processors change the value of the student data to generate the training data for at least a portion of the data items of the student data.

7. The prediction device according to claim 1, wherein the student data includes data items related to at least one of human relationship, lifestyle, learning habit, motivation for learning, and a factor affecting the promotion situation of the student.

8. The prediction device according to claim 1, , wherein the student data includes at least one of a credit acquisition rate and a GPA of the students for each subject category.

9. The prediction device according to claim 1, wherein the student data includes a credit acquisition rate of a subject category that affects the promotion situation of the student.

10. The prediction device according to claim 1, wherein the promotion situation includes at least one of repeating a year and leaving school of the students.

11. A prediction method comprising:
acquiring student data related to students;
generating training data based on the student data;
generating at least one model for predicting a promotion situation of a student based on the training data by machine learning; and
predicting the promotion situation of a subject student from the student data of the subject student using the model.

12. A non-transitory computer-readable recording medium recording a program, the program causing a computer to execute:
acquiring student data related to students;
generating training data based on the student data;
generating at least one model for predicting a promotion situation of a student based on the training data by machine learning; and
predicting the promotion situation of a subject student from the student data of the subject student using the model.
